(19) United States
(12) Patent Application Publication
(10) Pub. No.: US 2006/0036967 A1
(43) Pub. Date: Feb. 16, 2006

(54) Remote meter reading using transmitted visual graphics.

(76) Inventor: Henry B. Crichlow, Norman, OK (US)

Correspondence Address: HENRY CRICHLOW, 330 W. GRAY ST., SUITE 504, NORMAN, OK, 73069, US

(21) Appl. No.: 10/907,927

(22) Filed: Apr. 21, 2005

Related U.S. Application Data
(60) Provisional application No. 60/564,991, filed on Apr. 26, 2004.

(51) Int. Cl. G06F 3/00

(52) U.S. Cl. 715/781

(57) ABSTRACT

A technique for remote meter reading (RMR) of a plurality of meters uses visual image devices coupled to pattern recognition technologies to allow unattended meters, gages, registers, screens, and other similar display equipment to communicate their output data without human intervention to a central source and to provide this data on a global network. Historically, meters, gages and similar devices were either read by the human eye or by data-loggers and controllers which transmitted these data to a host system. With this invention the display devices can be read autonomously by the method described herein and a visual graphic of the meter face is transmitted to a host which then recognizes the data value embedded in the visual. Substantial increases in efficiency; performance and economics can be achieved with this invention which introduces the concept of “visualmetering”.

### CROSS REFERENCE TO RELATED APPLICATIONS

This application claims priority from provisional application No. 60/564,991 filed Apr. 26, 2004 by the inventor, Henry Crichlow. This application is related to application Ser. No. 10/016,049 filed Dec. 12, 2001, application Ser. No. 10/033,667, filed Dec. 27, 2001 and application Ser. No. 60/564,991 filed Apr. 26, 2004 filed by the inventor.

Normally, energy consumption devices shown in FIGS. 1 and 2 have to be read on a regular basis for billing and other operational purposes. This technology described herein involves the ability to substitute electronic and other devices for the human eye and the human brain in an effort to replicate the reading and recognition of the data on a meter face. In reading a meter a person first forms an image on the retina of the eye and this is transmitted to the brain by the optic nerve. The primary visual cortex lobe of the brain, which is charged with the recognition process, interprets the graphic image to determine the numerical or scalar values of the graphical data. A similar approach is used in this invention in which an image collector, normally some imaging technology collects an image at the meter or gage and transmits this image via a network link, to a computer system which decodes the image with a suitable algorithm to determine the values of the data indicate don the graphic representing the meter face. The concept proposed in this invention is “visual-metering” wherein inexpensive technology elements and robust software can replace expensive equipment and human intervention to economically solve the problems associated with reading meters, gages and output devices at un-attended and remote locations

### BACKGROUND OF THE INVENTION

1. Field of Invention

This invention is a unique and innovative method and system that enables the existing hundreds of millions of meters, gages and other visual based devices operational around the world to provide accurate meter data to their utility hosts in an economical and expeditious manner.

Hitherto, most metering functions required either a read by a human, or interrogation by a “drive-by” device or were connected to a network using some combination of automatic meter reading (AMR) equipment. The intent of the entire above schema was to determine what was the current value of the commodity data represented by the meter. AMR equipment is expensive to deploy and usually difficult to retrofit to older existing field equipment. This indicates a need for a technology that is cheap, easy to deploy and can interface with any type of existing or future meter system. The concept of visual-metering provides for this ability since the image collector device can collect the image off of any type of meter without any connection or physical interfacing with the meter itself or its internal working mechanism.

In 2003 there were 520,000,000 cell phones sold worldwide (Ref. 1). A growing percentage of these are the so-called picture phones (Ref. 2) which allow the user to transmit a picture to the party on the other end of the line which can read it, view and store it. In addition, it is now common practice for many commercial banks to have online the actual graphic image of the cancelled checks of its customers (Ref. 3) which can be reviewed by the customer from an online computer. This novel technology is now widely available, it is inexpensive and it is readily deployed. The internet and other networks are now ubiquitous and have reached the price point where mass utilization is becoming available. The convergence of these technologies prepares the foundation for the technology of visual-metering which makes remote meter reading a reality as described herein this invention.

In the past, the RMR focus has always been on the need for a separate piece of equipment, or an advanced meter or gage that converts the physical reading to an electronic form or electromechanical form that can be transmitted by a communication line to the central host. The primary need was the conversion process in which the meter signal was made compatible with some pre-existing format or protocol such that it could be transmitted. These protocols vary with all types of meters and operations. The method and system articulated herein provides a visual graphic which in essence replicates the human eye and a software interpreter or module subsequently extracts from the graphic the intelligent information which is the value of the meter reading. The core of software interpreter is an image processing software module (or software application system) that interprets the content of raw visual data, extracts the important information and converts it into “computer understandable” format. The software interpreter can utilize a graphic user interface (GUI) and can also include an Application Programming Interface (API) to allow the user to utilize maximum versatility.

In addition this visual graphic provides a permanent irrefutable record of the information at that time and along with a time-stamp, provides both consumer and the operator verifiable evidence of the information in times of uncertainty of the data interpretation.

In one aspect of the invention, a method and process is provided for determining the meter reading at a remote site.

In general, the method shown in overview in FIG. 1, comprises of the following broad activities:

Collecting an image of the current display of the meter, gage or output device under scrutiny by using an installed image collector device collocated at the meter or gage.

Preparing this collected image for transmission.

Transmitting this image to a host site for interpretation using an existing communication network.

Using software image analysis described herein which extracts the usable data from the visual graphic.

Archive the extracted data for future use.

With this invention, which involves in part, an image collector, an image transmitting system and an image interpreter computer based algorithmic system for the visual graphic, analysis major advances in RMR can be achieved with very little additional capital expenses and provide a level of accuracy and efficiency hitherto fore unknown in the industry. This technology is not limited to the electric industry which is the customary focus, but it can be used to visually-meter any of the following types of devices: pressure gages, temperature gages, dB devices, GPH, Kwhr, KVhr, HP, Kcal, flow computers, power meters, sensors, inclinometers, force meters, load meters, frequency meters. Specifically any output meter or recorder device which has a visible “face”, index, register or dial which whose image can be collected can be remotely read by this technology.

By way of illustration, FIG. 1 shows the typical metering system; the meter, the image collector and the network with the computer system and associated peripherals.

Meter reading is an integral part of industry and is a fundamental part of the electric power industry to provide a security of supply and for the orderly availability of electric power. The meter is literally the cash register of the electric, gas and water industries. There is a whole allied industry specializing in meter reading, meter reading tools and data management. By implementing this new invention new meters or existing meters can more effectively be read at lower cost and provide for continued development in the metering industries.

This new invention provides a method whereby all meters and gages can be read to provide RMR data without the need and expense costly add-on devices and major infrastructure enhancements.

This invention allows the orderly development and economical deployment of a remote metering systems, which require a simple add-on image collector-transmitter which puts a human eye-like system adjacent to the meter and to provide the needed recognition intelligence by software applications in the back room operations.

2. Description of Prior Art

Numerous inventions have been proposed for the remote meter reading industry in the prior art. These inventions have focused on various aspects of the problem to provide solutions.

U.S. Pat. No. 5,598,894 teaches a method in which a combination of stored templates and stored parameters that describe the face of the meter are used to identify the dial faces. Using computer feedback the method attempts to determine the meter reading values. The method also utilizes an illuminated diffuse light source to obtain the scanned image of the meter face.

In U.S. Pat. No. 5,870,140 an energy metering system is described which scans the energy meter face in response to a signal from a central processor unit. This method compares the image on consecutive images to determine the quantity of electric energy used. An elaborate camera with mirrors is used to collect the meter image. This technology also describes the delayed transmission of the collected data this requiring storage at the meter site.

U.S. Pat. No. 6,618,709 provides for a generalized data recorder at the meter unit, which allows the automatic reading of the energy over communication lines.

U.S. Pat. No. 6,208,266 publishes the use of optical imaging devices to prepare machine-readable scans of the utility meters. These optical imaging devices are further described as charge coupled optical elements. A remote host computer is used to process the data using dedicated OCR techniques.

U.S. Pat. No. 5,673,331 uses a video camera and a video recorder to record the meter as an image. In a very expensive and complicated process, the video signal is then digitized by a data interface, which is calibrated for the meter environment. Suitable mathematical algorithms to extract the meter data analyze the digitized video data.

U.S. Pat. No. 6,208,266 describes an extensive and complex hardware transmission system for data acquisition using an imaging device and a controller for the subject transmission system. A host computer is also described for storing the imaged data.

Patent GB 2,222,898 teaches a method wherein a hand-held device is held close to a specially modified meter, which then transmits an appropriate, optical, infrared, radio or ultrasonic signal to the hand-held device. This signal is received by the device and is de-coded, and the relevant items of information are stored in the memory. The meter reader then traverses all the meters in the system collecting the meter data.

Patent GB 2,345,566 provides an integrated, complex and expensive automatic meter reading device, comprising an imaging section connected to a character recognizing section for recognizing the contents of the display section which are imaged by the imaging section. An additional recording section for records the numerical data; and a control sections controls the total operations. A communication module allows the device to interact with a host machine.

Patent GB 2,371,664 actually describes a system wherein a meter reader takes a picture with a hand held digital camera of the face of the meter in the field. This camera is connected to a portable laptop-like computer which immediately displays the numeric output of the camera image on the screen. The numeric data is also stored for later use by the utility.

Patent FR 2,696,827 describes a system which allows hard-to-access meters to be read by a portable video camera which transmits the meter image on request to a more accessible visible video display device. It thus provides remote exterior access to normally interior and inaccessible meters.

Existing RMR systems suffer from having the necessity of one or more of the following elements or requirements as illustrated by the discussions of the prior art inventions. These are considered to be deficiencies in the prior art:
video recorders,
video cameras,
video digitizing software,
dedicated OCR systems,
stored templates to recognize meter types,
data recorders with controllers,
comparison systems to compare to previous images of meter data,
mirrors and other accessory devices,
remote CPUs to trigger transaction,
specialized illumination of meter face,
the meter face to have a fixed geometry, circular or other fixed type,
reference points like the center of meter faces to be identified,
translucent diffusers on light sources,
specially modified meters to aggregate the data.

This new invention provides a method whereby all meters, gages and related visual devices can be read to provide RMR data without the need and expense costly add-on devices, massively computationally intensive numerical processes and major infrastructure enhancements.

After careful consideration of the above noted problems and prior art solutions, the inventor has herein a novel and improved method and system that allows the meter systems data to be remotely read and utilized in a manner to achieve better day to day operations.

### SUMMARY OF THE INVENTION

This present invention has provided a novel technique for obtaining accurate data from a plurality of remote meter devices:

An object of this invention is to provide an improved visual image system to collect the usage data from a meter face.

A more specific objective is to provide an improved means of transferring the remote meter information from the meter to the host computer at the utility office.

A further objective is to increase the effectiveness of the RMR operation such that accurate and exact data and information can be transferred from the meter to the host system more reliably.

Another specific objective is to provide a novel system where the image from the RMR device can be transmitted via all available modes including the Internet, the World Wide Web and the VPNs.

Another specific objective is to provide a novel system wherein operational costs associated with meter reading can be minimized since manual meter reading, ride-by reading and drive-by reading are no longer required.

Another specific objective is to implement an improved means of increasing the meter's capability by allowing the meter data to be stored at a local RMR device for example an adjacent electric meter device, before being transmitted to the host computer.

Another objective is to implement accepted algorithmic processes in the software image analyzer such as, ANN, Fuzzy Logic, OCR in such a manner without having to make major capital investments in expensive and computationally difficult mathematical program like digitizing of video feeds and streaming video data with costly operations.

Another specific objective is to implement an improved means whereby the visual image data can be used by similar or dissimilar legacy systems.

Another specific objective is to implement an improved means of increasing the meter capability by allowing the meter identified data to be stored in a database in graphical form or as graphical objects with a timestamp to provide an irrefutable addressable record of the commodity usage.

Another specific objective is to implement an improved means of implementing a computer system apart from the meter site to provide an open source multi-layered architecture on a grid system for processing the visual graphic data and providing computer readable information of the meter data. [Para 51]Another specific objective is to implement an improved means such that this new system can be retrofitted to existing meter systems in the field or added to new systems at the manufacturing point.

Other objects and advantages of this invention will hereinafter appear.

### BRIEF DESCRIPTION OF THE DRAWINGS

These and other features of the subject invention shall be better understood in relation to the detailed description taken in conjunction with the drawings of which:

FIG. 1.—Overview of the invention.

FIG. 2.—Image collector connected to meter.

FIG. 3.—Image collector components

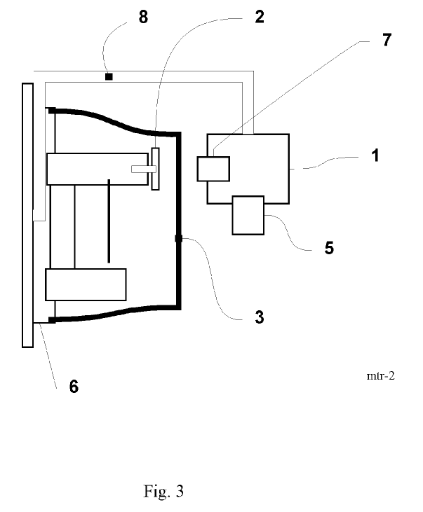

FIG. 4.—Meter Dials

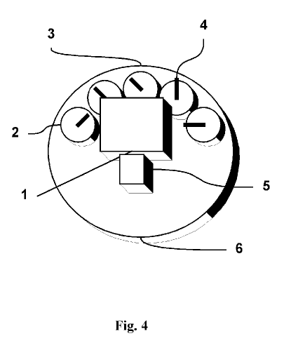

FIG. 5.—Human Vision analogy

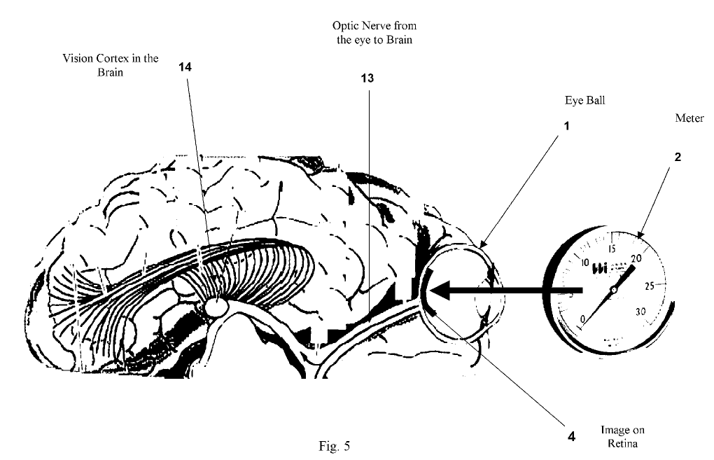

FIG. 6.—Elements of the Process

FIG. 7.—Meter dials with unique ID Number.

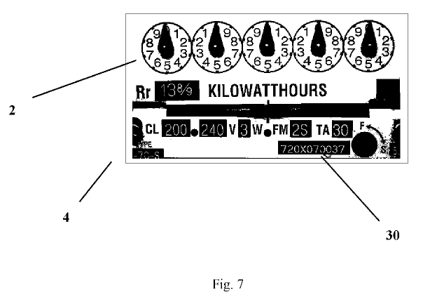

FIG. 8.—Image collectors connected to a local gateway.

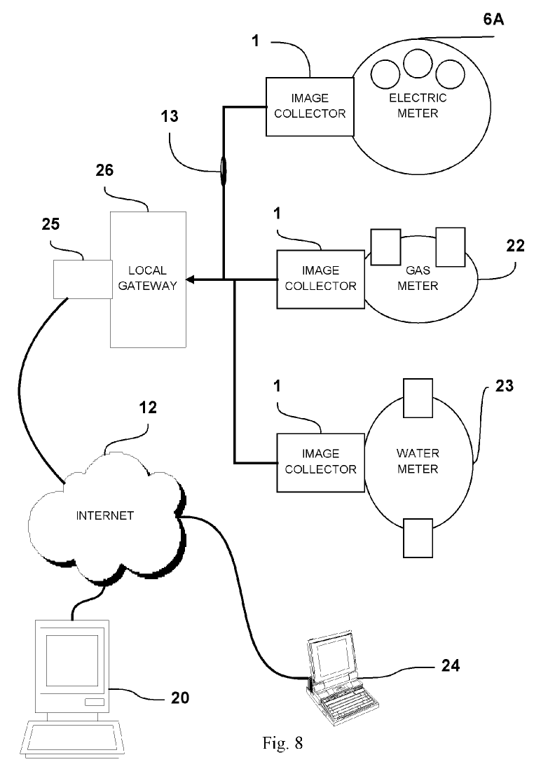

FIG. 9.—Serial segmentation of visual graphic image.

FIG. 10.—Online representation of utility gas bill.

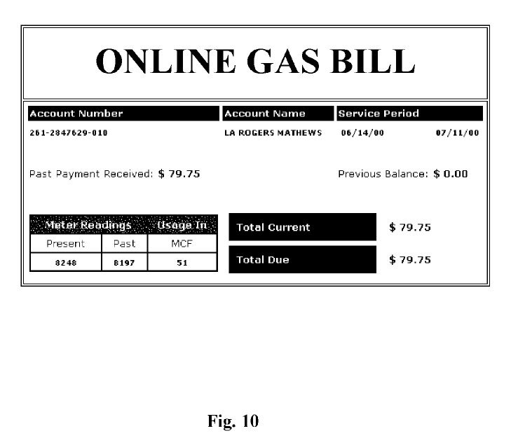

FIG. 11.—Online representation of utility water bill.

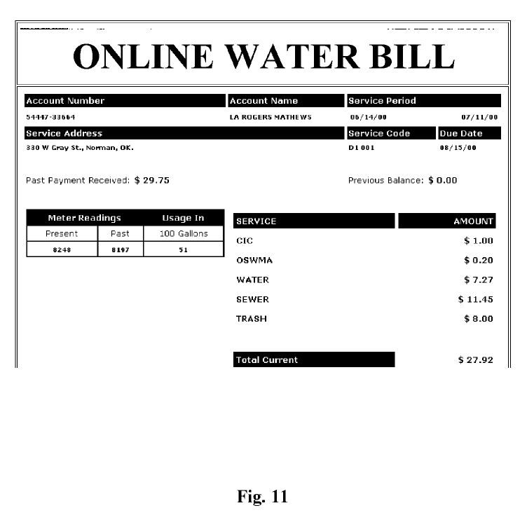

FIG. 12.—Online representation of utility electric bill.

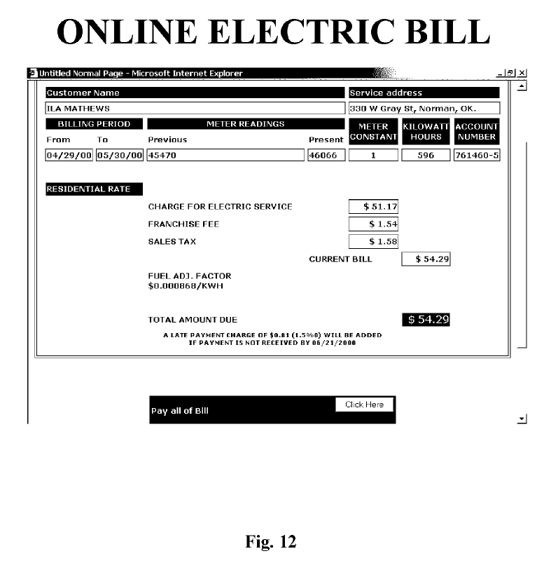

### DESCRIPTION OF ELEMENTS OF THE PREFERRED EMBODIMENTS

A preferred embodiment of the techniques of the present invention of “visual-metering” will now be described in the context of a typical RMR operation. Those skilled in the art, however, will recognize that the central ideas of the invention are not limited to the details enumerated below. Over the years meter reading has been made manually by human meter readers who literally walk the line and read each meter. Changes have allowed some companies to read meters by using special meters equipped with radio frequency transponders, which are both expensive and bulky to read meters; by “drive-by” operations using an antenna equipped truck. There are many systems with dedicated communication lines either wired, wireless, CATV, DSL or radio communication systems. The fundamental need is to get the meter reading data to the utility or operator as cheaply and as quickly as possible.

RMR needs are simple. Electric, gas, water and other utilities and other operators require a reliable system, an inexpensive system and a system that is ubiquitous. This invention allows the meter to be read using a simple reliable device coupled to sophisticated software algorithms which have become available in the current computer applications technology.

Current RMR costs are very large. Most RMR companies have focused on selling utilities a large complicated piece of hardware to maximize the RMR company's profit for this one time purchase. The invention described in this invention and those described in the companion patent filings describe a novel technology that departs drastically from the expensive hardware-driven approach to that of a simple inexpensive technology of these inventions. There is an installed base of over 265,000,000 electric meters across the country and conventional wisdom dictates that the industry in this deregulated cost cutting era is financially incapable of the capital expense of simultaneously lowering costs and upgrading with new expensive RMR system that require expensive technologies to operate.

In a typical embodiment of this invention in the field, the electric meter continually reads the energy usage and displays it on a set of dials or in a readout display. It can also be displayed in a digital display or on a digital odometer-like register. The utility needs this metered data to compile its bills which form the basis for its economic existence. The utility meter is the “cash register” of the industry. In the subject invention, the information from the meter or gage is collected by an image collector and transmitted directly or indirectly to a host computer at the utility location. Sophisticated algorithms in the host computer then “decode” the visual image providing the metered data in a machine usable form which is then used to compute the customer's usage of electric power.

The implementation of this new invention is different to existing conventional technologies by using a novel approach to collect the visual data, reduce the size of the visual data files, transmit the reduced data files to the host computer and algorithmically decode the visual image to obtain metered data, store it in a database and compile utility bills and display these bills online.

A detailed description is shown below. This embodiment provides a typical description and activity flow but it is no means exhaustive of the various approaches that can be implemented by one versed in the art.

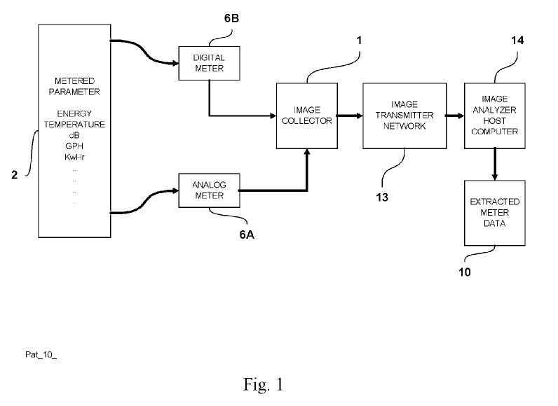

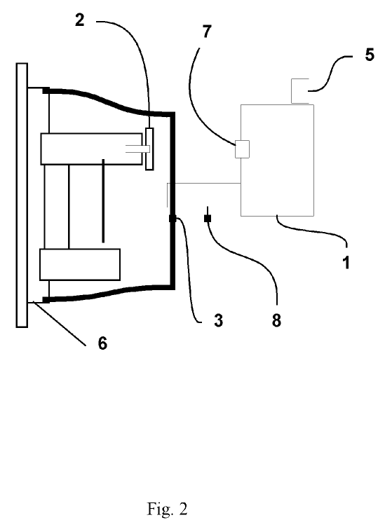

Referring to FIG. 1 and FIG. 2 which show generalized overviews of one embodiment of the invention, the system shows the image collector 1 installed at the meter assembly 6 with a support 8. The image collector 1 can use a “camera on a chip” technology (Ref. 4) or some similar imaging system in the visible or invisible spectrum and a lens 7 collects a visual graphic image 4 from either an analog meter 6A or digital meter 6B, 6C. In this embodiment, the image collector 1 takes an image of the clock dials 2 with the current positions of the needles on each dial through the protective transparent cover 3. The image collector initiates the image collection based on a pre-programmed internal mechanism or on a remotely from the host computer 14. The visual image 4 is stored at the image collector 1 and is relayed by the transmitter 5 directly to the host computer 14 by way of the Internet or some global network 12. Another option is to transmit the image 4 first to a gateway 26 and then through the Internet 12 eventually to the host computer 14. Since different physical processes require that meters be read at varying time intervals, using the gateway 27 approach as an intermediate option, allows the user to store and forward the visual image data 4 as needed. In a typical situation, electric data is usually needed at hourly intervals or at most daily, natural gas data, however, is usually needed at weekly or monthly intervals. More data is needed to be transferred with daily reads as opposed to monthly reads.

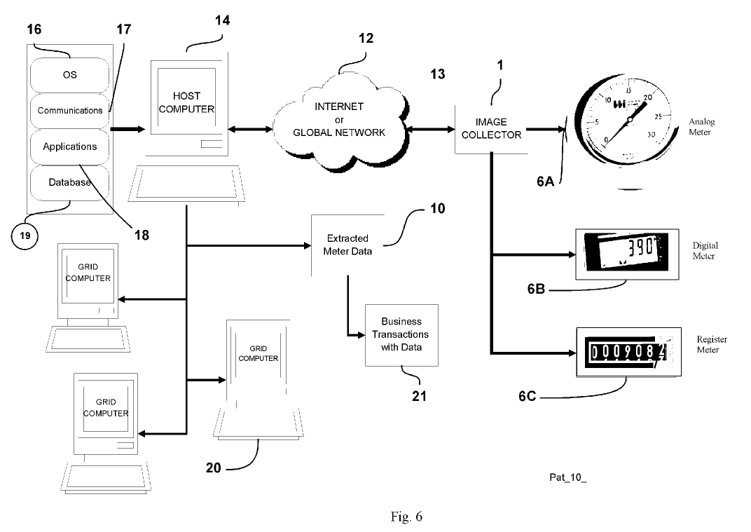

Referring to FIG. 6, the visual image 4 is accepted by the host computer 14 as a graphic file. The file is a typical computer file of the type BMP, GIF, JPEG or some other generally accepted format. The host computer 14 has an operating system 16, a communication system 17, application programs 18 and a database system 19. The applications program 18 process the image file 4 and determine the decode information 10 which is extracted for use in business transactions 21. A computational grid 20 made up of a plurality commodity type CPUs running an open source system like Linux (Ref.6) can process the data from hundreds of thousands of meters 6 in a timely or near real-time manner.

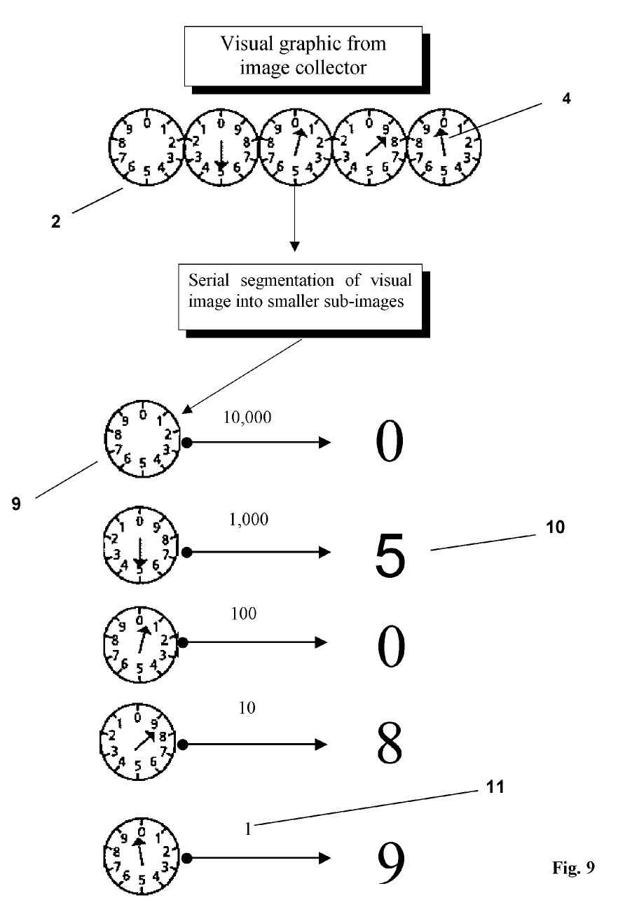

The applications program 18 implements among others, a suite of accepted industry standard pattern recognition systems. The pattern recognition model is part of standard mathematical analysis today. This computational methodology used, e.g. ANN, Fuzzy Logic, OCR among others, is not part of the invention since these mathematical processes are well known in the industry. In one embodiment, the application programs 18, first process the graphical file 4 using a serial segmentation process as shown in FIG. 9. In this operation the program breaks the image 4 in a plurality of sub-images 9, each sub-image is smaller in size and is then “decoded” more rapidly since there is less image using the host computer programs to extract the appropriate data 10. Each sub-image is associated with a multiplicative factor 11 and the complete data number is reconstructed by combining these extracted digits and their associated multiplicative constants. Processing sub-images is very fast and a preferred approach shown in this embodiment since in a typical physical field location only the right-most or lower value dials change, the higher value dials, e.g. the 100,000 value dial, usually change very slowly, maybe once every 5 years, and in some cases not at all. Internal programming functions can indicate that the smallest number of “dials” that have changed since the previous read, be processed

The business transaction section 21 of the applications program 18 uses the extracted data 10 to compute the energy use according to the company tariffs. The host computer then archives the extracted data 10 and the graphic file 4 with a time stamp and identification record in a database 19 for future use. The computed energy use is then displayed on the internet as a bill 28.

Having shown above a detailed embodiment of the subject invention, it will occur to those skilled in the art that modifications and alternatives can be practiced within the spirit of the invention. For instance, it will be appreciated that the above procedure is equally applicable to any and all types of visual data in the field that needs to be collected from remote sites and accordingly the spirit and scope of the subject invention should not be limited to the specific details in the embodiments above.

| Abbreviation | Meaning |
|---|---|
| AMR | Automatic Meter Reader |
| ANN | Automatic Neural Network |
| API | Applications Program Interface |
| BMP | Graphic file format - BitMap |
| CDMA | Code Division Multiple Access |
| CDPD | Cellular Digital Packet Data |
| CPU | Central Processing Unit |
| dB | decibel |
| DSL | Digital Subscriber Line |
| EPI | Energy Performance Index |
| FTP | File Transfer protocol |
| GB | Great Britain |
| GIF | Graphic file format - Graphic interchange format |
| GPH | Gallons per Hour |
| GSM | Global System Mobile Communication |
| GUI | Graphical User Interface |
| HP | Horse power |
| ID | Identification |
| ISP | Internet Service Provider |
| JPEG | Graphic file format - Joint Photography Group |
| KW | Kilowatt |
| OCR | Optical Character Recognition |
| OS | Operating System |
| PCS | Personal Communication Services |
| PLC | Powerline carrier |
| PSTN | Public Switched Network |
| RAM | Random Access Memory |
| RF | Radio Frequency |
| RMR | Remote Meter Reading |
| TDMA | Time Division Multiple Access |
| VPN | Virtual Private Network |
| WAP | Wireless Application Protocol |
| WWW | World Wide Web |
| x.25 | Modem usage protocol |

| No | List of Items |
|---|---|
| 1 | Image collector |
| 2 | Clock dial of meter face |
| 3 | Transparent meter cover |
| 4 | Visual Image on analog dial |
| 5 | Image collector transmitter element |
| 6 | Meter assembly |
| 6A | Analog Circular meter |
| 6B | Digital meter output |
| 6C | Digital Register meter |
| 7 | Camera lens |
| 8 | Image collector support mechanism |
| 9 | Sub element of visual image |
| 10 | Extracted data from sub-image |
| 11 | Multiplicative factor for sub-image element |
| 12 | Internet or global network |
| 13 | Communications lines |
| 14 | Host Computer System |
| 15 | Multi-layered Computer Software |
| 16 | Operating System |
| 17 | Communications software |
| 18 | Applications Programs |
| 19 | Database |
| 20 | Computing Grid |
| 21 | Business Transactions |
| 22 | Gas meter |
| 23 | Water meter |
| 24 | User computer |
| 25 | Communication device |
| 26 | Local gateway device |
| 27 | Unique Meter ID number |
| 28 | Gas Bill online |
| 29 | Water Bill online |
| 30 | ID Number of meter |

What is claimed is:

1] What is claimed is a computer implemented method and system for improved reading of remote meters or gages that have visible faces or dials, with digital or analog output, including the following elements of the invention, image collector device, image transmitter device, communications network, utility meter or gage, host computer system, communication apparatus, internet and WWW, algorithmic pattern recognition processor, pattern recognition algorithms, database of image information, communication network and comprising the steps of:
installing the image collector device at the meter or gage or in the meter,
making a visual graphic of the meter face,
including the unique meter ID on the visual graphic,
storing this graphic in the image collector,
preprocessing the image graphic at the image collector,
transmitting the visual graphic to an intermediate device before transmitting to host computer,
transmitting the visual graphic to the host computer directly,
post processing the visual graphic before analysis,
analyzing the visual graphic using selected computer image analysis algorithms,
using a segmented system for processing the graphic image,
extracting from the graphic the scalars or values of the metered parameter,
providing the extracted data to an end user,
storing the visual graphic for further analysis in a database.
making the database available online on a global network,
updating the database with the current visual graphic.

2] Method and process set forth in claim 1 wherein the image collector system comprises:
a “camera on a chip” system.

3] Method and process set forth in claim 1 wherein the image collector system comprises:
a still video camera system.

4] Method and process set forth in claim 1 wherein the image collector system comprises:
a digital camera system.

5] Method and process set forth in claim 1 wherein the image collector system comprises:
means for providing light to the meter face if needed;
means for determining if there is sufficient illumination for obtaining the graphic image of the meter face;
means for using visible light;
means for using infrared light;
means for using the non-visible spectrum for image generation;
means for obtaining a graphic image of the meter face;
means for storing graphic image in image collector;
means for preprocessing the graphic image to lower the data requirements for local storage;
means for preprocessing the graphic image to lower data requirements for transmission to shorten transmission times;
means for transmitting an error code in the event of an alarm;
means whereby the image collector operates in autonomous mode without need for trigger commands from the host computer;
means for the graphic image to be collected from analog meters or gages;
means for the image to be collected from digital meters or gages;
means for the graphic images to be collected from mechanical registers.

6] Method and process set forth in claim 1 wherein the image collector system comprises:
means for communication directly to a host computer by a plurality of means including, wired or wireless systems such as the PSTN, PCS, DSL, CDMA, CDPD, PCS, TDMA, GSM, x.25, cellular, RF, PLC or satellite communications modes.

7] Method and process set forth in claim 1 wherein the image collector system comprises:
means for communication initially to an intermediate device such as a local meter gateway element which then connects to the host computer by a plurality of means including, wired or wireless systems such as the PSTN, cellular, RF, PLC or satellite communications modes.

8] Method and process set forth in claim 1 wherein the image collector system forms a local network with an adjacent meter gateway element.

9] Method and process set forth in claim 1 wherein the image collector system is connected to a VPN.

10] Method and process set forth in claim 1 wherein the image collector system has its own internal power source.

11] Method and process set forth in claim 1 wherein the image collector system derives power form an external power source comprising;
the meter being read,
the telephone line system,
the powerline carrier system or
from photo-electric systems.

12] A computer system comprising:
a CPU; RAM and
computer software system embodied in a storage medium, comprising:
at least one external interface to communicate with systems external of said computer; and
a multi-layered distributed software architecture comprising:
application and infrastructure subsystems, said application and infrastructure subsystems comprising services, distributed throughout said computer, that collaborate to complete predefined processing functionalities;
middleware software, said middleware software being provided to allow scalability, and
transaction processing, mapping of objects to data repositories; and
application frameworks, said application frameworks allowing access to said database repositories and the creation of processes conforming with subject middleware software.

13] The computer system as set forth in claim 12, wherein the computer system connected to RMR system by wired or wireless communication systems.

14] The computer system as set forth in claim 12, wherein the host computer connected to global communications networks such as the internet or WWW.

15] The computer system as set forth in claim 12, wherein said host computer system can reside in a local, regional, national or offshore location.

16] The computer system as set forth in claim 12, wherein said host computer system comprises an export subsystem.

17] The computer system as set forth in claim 16, wherein said export subsystem exports data to external applications systems.

18] The computer system as set forth in claim 12, wherein the computer system is connected to similar legacy systems.

19] The computer system as set forth in claim 12, wherein the computer system is connected to dissimilar legacy systems.

20] The computer system as set forth in claim 12, wherein the computer system is connected to and forms part of a distributed network system.

21] The computer system as set forth in claim 12, wherein the computer system utilizes an open source operating and programming language system.

22] The computer system as set forth in claim 12, wherein the computer system is adapted to support a fail-over capability at all levels in the event of a failure, and wherein an individual process fails, said computer system shifts failed processes to another process, and wherein if a communications system fails, automatic routing to other communication systems is established.

23] The computer system as set forth in claim 12, further comprising a graphical user interface which interacts with said application subsystem and provides at least one of access to said computer system to manually invoke all business system interfaces online, search specific information, provide access to an activity management system monitor, and provide an interface to other business operations.

24] The computer system as set forth in claim 23, wherein said graphical user interface uses standard application system application programming interfaces provided by said utility interface to initiate requests.

25] The computer system as set forth in claim 12, wherein the applications programs comprise:
at least one image analysis means for processing the visual graphic images; and,
at least one image analysis means for processing the visual graphic images in such a manner to produce scalar information indicating the parameter values represented by the meter reading.

26] The method as set forth in claim 1, wherein the using step of said image analysis applications program includes a serial segmentation process wherein the visual image is divided or segmented into smaller multiples sub-elements; and,
means wherein each sub-element is analyzed separately; and,
means wherein the data value is extracted from each sub-element; and
means wherein the data values are aggregated to determine the complete and correct data value embedded in the visual graphic.

27] The method as set forth in claim 1, wherein the using step of said image analysis applications program analyses the current visual graphic only independent of the existence of the previous visual graphic from the same meter.

28] The method as set forth in claim 1, wherein the using step of said image analysis applications program analyses the visual graphic images without need for stored templates of meter images in the computer.

29] The method as set forth in claim 1, wherein the using step of said image analysis applications program saves the image with the unique ID number of the meter for later cross references and archival purposes.

30] The method as set forth in claim 1, wherein the using step of said image analysis applications program exports the visual graphic data to a relational database for data storage.
